(19) United States
(12) Patent Application Publication
(10) Pub. No.: US 2026/0022769 A1
(43) Pub. Date: Jan. 22, 2026

(54) WEAR SLEEVE AND LIP SEAL POSITIONABLE UPON A MACHINE COMPONENT

(71) Applicant: Caterpillar Inc., Peoria, IL (US)

(72) Inventors: Gabriel S. Ferreira, Peoria, IL (US); Jennifer L. Wilson, East Peoria, IL (US); Wesley A. Thill, Peoria, IL (US)

(73) Assignee: Caterpillar Inc., Peoria, IL (US)

(21) Appl. No.: 18/777,714

(22) Filed: Jul. 19, 2024

(51) Int. Cl. F16J 15/3204

(52) U.S. Cl. CPC F16J 15/3204

(57) ABSTRACT

A seal assembly includes a wear sleeve, the wear sleeve having an outer sleeve surface made of a fluoropolymer material and a lip seal made of an elastic material and fitted upon the wear sleeve. The lip seal defines a seal axis extending between a first axial seal end and a second axial seal end and includes an outer seal surface and a circumferentially extending inner seal surface forming an opening receiving the wear sleeve. The lip seal further includes a sealing lip in sealing contact with the outer sleeve surface.

### TECHNICAL FIELD

The present disclosure relates generally to a seal assembly, and more particularly to a low-friction wear sleeve in a lip seal assembly.

### BACKGROUND

Many machine components and systems, such as a yoke positioned between a driver, such as an engine, and a transmission, utilize lip seals to ensure effective sealing against contaminants and lubricant leakage. Typically, the lip seal is attached within a yoke assembly, often through press-fit or other bonding or mounting methods, to ensure a secure fit. These seals are commonly located in positions where shafts couple to the yoke forming a barrier that prevents the ingress of debris and moisture while retaining lubricants within the system. In some applications, wear sleeves are used in conjunction with lip seals to provide additional protection against shaft wear and extend the seal life.

The wear sleeve in such examples typically includes durable materials like stainless steel, and provides a smooth surface for the lip seal to contact. Preventing oil or other lubricants from leaking into undesired locations mitigates the risk of contaminating surrounding components and limits undesired lubricant consumption.

Friction between moving components can gradually wear down wear sleeves and lip seal materials, compromising sealing effectiveness over time. Various factors motivate ongoing advancements in both wear sleeve and lip seal design, including extending time between service and optimizing seal performance. One known lip seal assembly for a crankshaft is set forth in U.S. Pat. No. 3,917,286 to Loyd. In the concept set forth in Loyd a metal case lip seal is detachably mounted in a bore of an engine block and includes a flexible annular lip of a sealing element that sealingly contacts a crankshaft.

### SUMMARY

In one aspect, a machine assembly includes a machine component defining a component axis, and a wear sleeve having an inner sleeve surface upon the machine component and an outer sleeve surface made of a fluoropolymer material. The machine assembly also includes a lip seal having an outer seal surface, an inner seal surface, and a sealing lip in sealing contact with the outer sleeve surface at an axial location.

In another aspect, a seal assembly includes a wear sleeve made at least in part of a fluoropolymer material. The wear sleeve also defines an axis extending between a first axial sleeve end and a second axial sleeve end, and the wear sleeve further includes a radially inward inner sleeve surface and a radially outward outer sleeve surface. The seal assembly also includes a lip seal made of an elastic material and structured to fit upon the wear sleeve. The lip seal includes a radially outward portion and a radially inward portion having a sealing lip structured for sealing contact with the outer sleeve surface at an axial location so as to form a sealing interface extending fully circumferentially around the axis.

In yet another aspect, a seal assembly includes a wear sleeve, the wear sleeve having an outer sleeve surface made of a fluoropolymer material, and a lip seal made of an elastic material and fitted upon the wear sleeve. The lip seal defines a seal axis extending between a first axial seal end and a second axial seal end, and includes an outer seal surface, and a circumferentially extending inner seal surface forming an opening receiving the wear sleeve. The lip seal further includes a sealing lip in sealing contact with the outer sleeve surface.

### BRIEF DESCRIPTION OF DRAWINGS

FIG. 1 is a perspective view of a machine assembly, according to one embodiment;

FIG. 2 is a perspective view of a seal assembly for a machine assembly as in FIG. 1;

FIG. 3 is a sectioned view, in perspective, of a wear sleeve for a seal assembly, according to one embodiment;

FIG. 4 is a sectioned view of a portion of a seal assembly, according to one embodiment; and

FIG. 5 is a sectioned view of a portion of a seal assembly, according to one embodiment;

### DETAILED DESCRIPTION

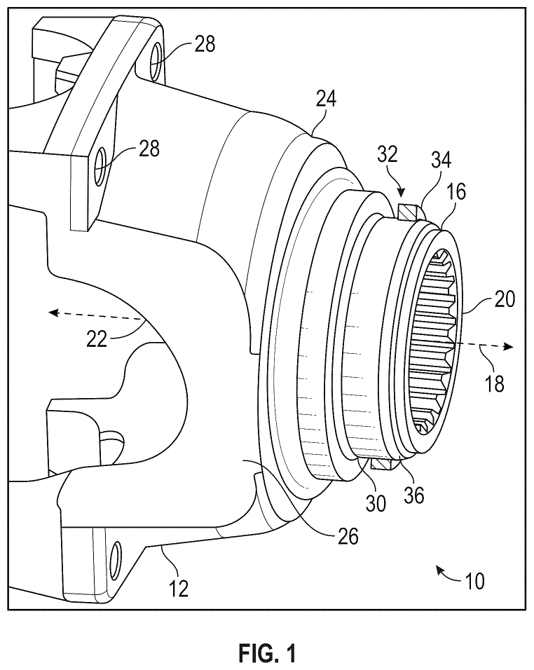

Referring to FIG. 1, there is shown a machine assembly 10, according to one embodiment. Machine assembly 10 includes a machine component 12 structured to rotate in a machine system 14. Machine assembly 10 may include or be coupled to an internal combustion engine, such as a diesel engine. In this context, machine assembly 10 can have transmission applications and other heavy-duty uses which may utilize seals between rotating components, to facilitate prevention of fluid leakage and contamination and facilitating lubrication. Machine component 12 may also include a shaft 16 defining a shaft axis 18 extending between a first axial end 20 and a second axial end 22. In a practical implementation, shaft 16 may be a distinct part or integrally formed as part of a more complex machine component.

Machine component 12 can include a yoke 24 (as shown) used in connecting an engine to a transmission, or other machine components, such as various shafts within rotating machinery which require sealing and lubrication. In the illustrated embodiment, yoke 24 includes a yoke body 26 and fasteners 28 to couple yoke 24 with other components in a generally conventional manner. It will thus be appreciated that machine component 12 facilitates transmitting rotational power to a device to be driven without limitation. Yoke 24 may connect to a rotatable shaft (not shown) which can be received in a splined opening 30 in yoke 24, such as an input shaft to a transmission, a torque converter, a power take-off, etc. Seal assemblies connected to shafts may gradually degrade over time with extended use. The present disclosure is directed to optimized performance and extended service life of seal assemblies in machine applications.

To this end, machine assembly 10 further includes a seal assembly 32 positionable upon machine component 12. Seal assembly 32 includes a wear sleeve 34 and a lip seal 36. In a practical implementation, seal assembly 32 may further include a seal housing 38. Further, seal housing 38 may be formed of a metallic material such as steel although non-metallic materials are within the scope of the present disclosure. Each of wear sleeve 34 and lip seal 36 extends circumferentially around shaft axis 18. Wear sleeve 34 and lip seal 36 each define axes extending from a first axial end toward a second axial end, notwithstanding their shared axis with machine component. For clarity, this shared axis will be termed “center axis 18” herein.

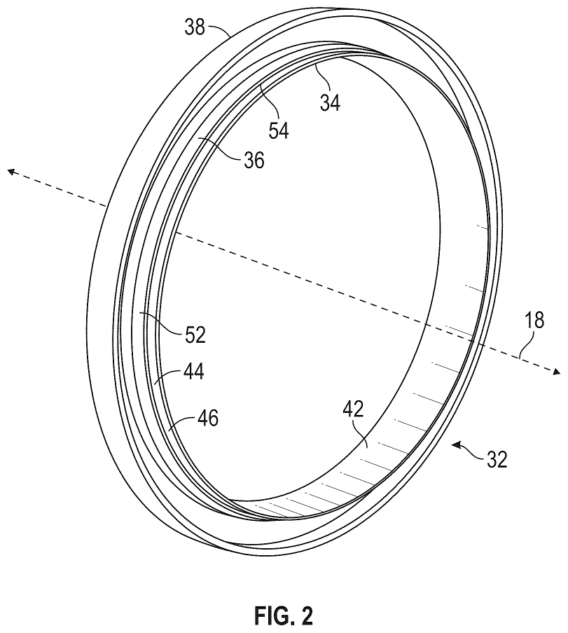

Referring also now to FIGS. 2-5, wear sleeve 34 includes a wear sleeve body 40, a radially inward inner sleeve surface 42 upon machine component 12, and a radially outward outer sleeve surface 44 having a running surface 46 therein. Running surface 46 may be independently positioned on outer sleeve surface 44 or integrally formed into wear sleeve 34, providing a mounting surface and sealing surface for lip seal 36. Wear sleeve 34 may also define a wear sleeve length 48 between first axial sleeve end 20 and second axial sleeve end 22. Further, wear sleeve 34 can have a uniform sleeve thickness 50, in a radial direction, along at least a portion of wear sleeve length 48, although the present disclosure is not thereby limited to such. Wear sleeve 34 may also be formed at least in part of metallic materials, non-metallic materials, composites, etc., as further discussed herein. As will be further apparent from the following description, seal assembly 32 is uniquely structured for lubrication and sealing about machine component 12 and exclusion of debris when installed for service.

Lip seal 36 includes a radially outward outer seal surface 52 and a radially inward inner sleeve surface 54, each extending from a first axial seal end 20 to a second axial seal end 22. Each outer seal surface 52 and inner seal surface 54 circumferentially extend around center axis 18. In a practical implementation, seal assembly 32 may further include a seal jacket 56 surrounding lip seal 36 positionable upon running surface 46. Lip seal 36 is structured for sealing contact with outer sleeve surface 44 at an axial location 60 so as to form a sealing interface 62 extending fully circumferentially around center axis 18. When installed for service, running surface 46 is rotatable relative to lip seal 36. Lip seal 36 may have at least some internal elastic resiliency, such that when unbiased lip seal 36 has a tendency to assume a form closer to planar (as shown in FIG. 2). Accordingly, lip seal 36 may be formed of an elastic material, such as rubber or rubber-like materials, which may be natural or synthetic. Elastic deformation stretches lip seal 36 in an axial direction to define the location of sealing contact that is spaced axially from seal housing 38. In a practical implementation, lip seal 36 may be elastically deformed in circumferential sealing contact between seal housing 38 and outer sleeve surface 44 at axial location 60. Deformation of lip seal 36 against an internal bias can assist in maintaining a radially inward squeeze about the center axis 18.

Seal assembly 32 may be positioned upon machine component 12 to provide low friction sealing which can be easily replaced at recommended intervals, or as needed in the case of wear or damage. As shown in FIG. 1, wear sleeve 34 extends through lip seal 36 and is positioned radially between machine component 12 and lip seal 36, and may be interference-fitted upon machine component 12 in some embodiments. Wear sleeve 34 may also extend further than lip seal 36 in both axial directions when positioned upon wear sleeve 34. Wear sleeve 34 may form an assembly with other components and can be sold as such an assembly.

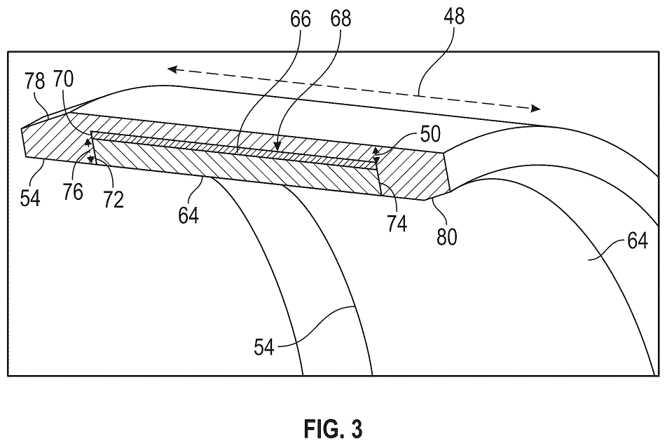

As noted above, wear sleeve 34 can include various suitable materials and, in some embodiments, may be formed of more than one material. Suitable materials may include a fluoropolymer. It will be appreciated that a fluoropolymer within the present description may include polytetrafluorethylene (PTFE) although other known fluorpolymer materials might be used. In one example, outer sleeve surface 44 may be made of a fluoropolymer, whereas at least certain other portions of wear sleeve 34 are formed of a metallic material. In another example, such as in FIG. 3, wear sleeve 34 may be formed of PTFE and may further include a metallic element 64 forming inner sleeve surface 42. Although the present discussion describes metallic element 64 forming inner sleeve surface 42, the present description is not limited to such, and alternative configurations of metallic elements are within the scope of the present description. For example, metallic element 64 may form wear sleeve body 40, and running surface 46 may be formed of PTFE as a coating or an additional thin sleeve upon an inner sleeve formed by metallic element 64, and still others. Metallic element 64 may be fitted upon machine component 12 utilizing various methods, such as interference-fitting for example.

In another example, wear sleeve body 40 may be made principally of PTFE and may further include an adhesive 66 securing metallic element 64 to wear sleeve body 40. Application of adhesive 66 may be accomplished by various methods and techniques, such as including an adhesive bonding layer 68 securing metallic element 64 to wear sleeve body 40 made of a fluoropolymer such as PTFE. Wear sleeve 34 may further include a slot 70 formed within inner sleeve surface 42, and metallic element 64 may be seated within slot 70. Slot 70 may include a first end slot surface 72 and a second end slot surface 74, and metallic element 64 is positioned between first end slot surface 72 and second end slot surface 74. In this particular example, inner sleeve surface 42 may be made of a fluoropolymer material at least at locations axially outward of slot 70, and metallic element 64 can form a majority of an axial length of wear sleeve length 48. Metallic element 64 may include a metallic element thickness 76 greater than wear sleeve thickness 50. It will be appreciated that the present discussion is exemplary in illustrating arrangements of wear sleeve materials and metallic elements, and alternative material compositions of wear sleeve 34, inner sleeve surface 42, and outer sleeve surface 44 are within the scope of the present disclosure.

Wear sleeve 34 and metallic element 64 may also be formed into a variety of shapes, provided when installed for service seal assembly 32 remains securely attached to machine component. In one example, such as in FIG. 3, outer sleeve surface 44 may further include an outer sleeve taper 78 and inner sleeve surface 42 may include an inner sleeve taper 80. It will be appreciated that each taper 78, 80 presents a diagonal placement (as shown in FIG. 3), with consideration given to additional placement, angles, and orientations. In another example, metallic element 64 may be formed into a cylindrical shape. It will further be appreciated that each arrangement is exemplary, and other shapes and forms of wear sleeve 34 and metallic element 64 are within the scope of the present disclosure provided wear sleeve 34 can accommodate metallic element 64 when employed.

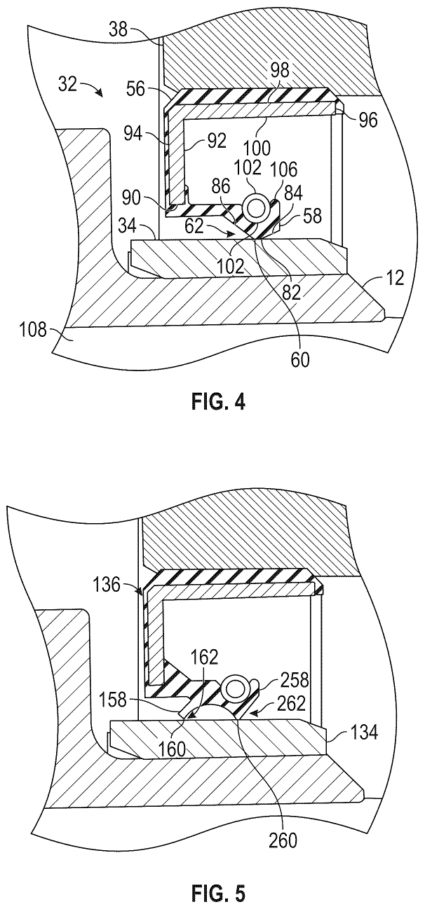

Focusing on FIG. 4, as suggested above, lip seal 36 is structured for sealing contact with running surface 46. Accordingly, lip seal 58 may also include a sealing edge 82 positioned between a first sealing edge planar surface 84 and a second sealing edge planar surface 86. When positioned upon machine component 12, sealing edge 82 contacts wear sleeve 34 at axial location 60, providing a barrier and facilitating protection against contaminants. Seal assembly 32 may further include a metal frame 88. Metal frame 88 may include an L-shape in cross-section and provides structural support to lip seal 36 to support and position lip seal 36 in a generally conventional manner. Metal frame 88 may include a vertical portion 90 having an internal front surface 92 and an internal back surface 94, and a horizontal portion 96 having an internal top surface 98 and an internal bottom surface 100. Lip seal 36 may further include a spring 102 positioned in a spring groove 104 within lip seal 36. Lip seal 36 may also include a spring lip 106 adjacent to spring 102. Generally, spring 102 is positioned in close proximity to running surface 46, and provides an inward radial force on sealing lip 36 to facilitate continuous sealing contact.

Focusing now on FIG. 5, there is shown another seal assembly 132 according to another embodiment. Seal assembly 132 may be structured akin to seal assembly 32, and the description of any embodiment discussed herein applies to any other unless expressly stated otherwise or evident from context. Lip seal 136 may further include a second sealing lip 158 adjacent to a first sealing lip 258. Sealing lips 158,258 is structured for sealing contact with outer sleeve surface 144 at a first axial location 260 and a second axial location 160 so as to form a first sealing interface 262 and a second sealing interface 162 extending fully circumferentially around center axis 18. When positioned upon machine component 12, the two sealing lips ride in contact with wear sleeve 134 at a first axial location 260 and second axial location 160, respectively. Lip seal 136 might be utilized when a machine component 12 is more susceptible to greater levels of dust and debris ingression, higher pressure differentials, higher running speeds, or other instances where redundant or enhanced sealing efficacy is considered desirable.

### INDUSTRIAL APPLICABILITY

When machine assembly 10 is installed for service, wear sleeve 34 can be interference-fitted upon machine component 12 and seal housing 38 can be interference-fitted with a housing 108. Housing 108 may be a machine housing or a machine component housing and can further isolate seal assembly from debris and other contaminants. Wear sleeve 34 being constructed using one or more non-metallic low friction materials to form the sealing interface with a lip seal, such as PTFE, may minimize friction. By utilizing materials having such low friction properties, wear sleeve may experience reduced heat generation, which in turn may extend service life. Wear sleeve 34, and other embodiments contemplated herein, may be sold as part of a seal assembly in combination with a lip seal as part of original equipment, such as a transmission system, an engine assembly, or a built machine, or as an aftermarket part available to swap out for existing seals during machine system overhaul or routine servicing.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A machine assembly comprising:
a machine component rotatable around a component axis:
a wear sleeve having an inner sleeve surface in contact with the machine component, an outer sleeve surface made of a fluoropolymer material, and the inner sleeve surface is formed at least in part by the fluoropolymer material; and
a lip seal including an outer seal surface, an inner seal surface, and a first sealing lip in sealing contact with the outer sleeve surface at a first axial location.

2. The machine assembly of claim 1 wherein the lip seal is elastically deformed in circumferential sealing contact with the outer sleeve surface at the axial location.

3. The machine assembly of claim 2 further comprising a seal housing, and the elastic deformation of the lip seal includes elastic deformation stretching the lip seal in an axial direction so as to space the axial location of sealing contact axially outward of the seal housing.

4. The machine assembly of claim 1 wherein the wear sleeve further includes a metallic element forming the inner sleeve surface at least in part.

5. The machine assembly of claim 4 wherein the wear sleeve further includes a wear sleeve body, and an adhesive securing the metallic element to the wear sleeve body.

6. The machine assembly of claim 1 wherein the lip seal further includes a second sealing lip.

7. The machine assembly of claim 6 wherein the first sealing lip and the second sealing lip ride in contact with the wear sleeve at the first axial location and a second axial location, respectively.

8. A seal assembly comprising:
a wear sleeve made at least in part of a fluoropolymer material, and defining an axis extending between a first axial sleeve end and a second axial sleeve end, and the wear sleeve further including a radially inward exposed inner sleeve surface defining an unobstructed opening circumferentially around the axis and diametrically across the wear sleeve, and a radially outward outer sleeve surface; and
a lip seal made of an elastic material and structured to fit upon the wear sleeve, the lip seal including a radially outward portion and a radially inward portion having a sealing lip structured for sealing contact with the outer sleeve surface at an axial location so as to form a sealing interface extending fully circumferentially around the axis.

9. The seal assembly of claim 8 wherein the wear sleeve has a uniform thickness, in a radial direction, along at least a portion of a wear sleeve length between the first axial sleeve end and the second axial sleeve end.

10. The seal assembly of claim 8 further comprising a seal housing, and wherein the lip seal is fitted upon the wear sleeve and at least one of the first axial sleeve end or the second axial sleeve end extends axially outward of the seal housing.

11. The seal assembly of claim 8 wherein the fluoropolymer includes polytetrafluorethylene (PTFE).

12. The seal assembly of claim 8 wherein the lip seal further includes a second sealing lip structured for sealing contact with the outer sleeve surface so as to form a second sealing interface at a second axial location.

13. The seal assembly of claim 12 wherein the wear sleeve further includes a metallic element attached to the fluoropolymer material.

14. The seal assembly of claim 13 further including an adhesive bonding layer securing the metallic element to the fluoropolymer material.

15. A seal assembly comprising:
a wear sleeve, the wear sleeve having an outer sleeve surface made of fluoropolymer material:
the wear sleeve further including an inner sleeve surface forming a slot, and a cylindrical metallic element seated within the slot and forming the inner sleeve surface at least in part; and
a lip seal made of an elastic material:
the lip seal defining a seal axis extending between a first axial seal end and a second axial seal end, and including an outer seal surface and a circumferentially extending inner seal surface forming an opening receiving the wear sleeve; and
the lip seal further including a sealing lip in sealing contact with the outer sleeve surface, and the outer sleeve surface forming a running surface rotatable relative to the sealing lip.

16.-18. (canceled)

19. The seal assembly of claim 15, wherein the inner sleeve surface is made of fluoropolymer material at locations axially outward of the slot.

20. The seal assembly of claim 19 wherein the metallic element forms a majority of an axial length of the inner sleeve surface.
